(19) United States
(12) Patent Application Publication
(10) Pub. No.: US 2002/0072952 A1
(43) Pub. Date: Jun. 13, 2002

(54) Visual and audible consumer reaction collection

(75) Inventors: Mark Joseph Hamzy, Round Rock, TX (US); Rabindranath Dutta, Austin, TX (US)

Correspondence Address: Robert H. Frantz, P.O. Box 23324, Oklahoma City, OK, 73123-2334, US

(73) Assignee: International Business Machines Corporation

(21) Appl. No.: 09/731,870

(22) Filed: Dec. 7, 2000

(51) Int. Cl. G06F 17/60

(52) U.S. Cl. 705/10; 705/14

(57) ABSTRACT

Collection of visual and audible reactions of a consumer while viewing or experiencing Internet advertising messages is made using the multimedia capabilities of a client device, such as a PC camera and/or a microphone. The presentation of advertising messages on a web client device display or speakers is timed, and visual images of the face of the user and audible recordings immediately subsequent to displaying or presenting the advertisement are captured and digitized. The digitized image and audio is transmitted marketing server, where they are processed for recognition of features, such as certain words in a sound file or certain expressions in a facial image. Multiple reactions from a plurality of consumer users may be aggregated to provide a more generalized consumer reaction measure to a marketing campaign based on a selected group of consumers according to their common demographic characteristics. Further, each individual consumer can be delivered different advertising messages depending on their detected reactions to previous similar messages, thus tailoring the marketing campaign to the individual consumer and maximizing the effectiveness of the campaign.

### BACKGROUND OF THE INVENTION

1. Field of the Invention

This invention relates to the arts of marketing studies, the methods used and the technologies used for collecting marketing information for advertisement, and Internet advertising technologies. This invention relates especially to methods and technologies for conducting observed consumer reaction to marketing messages over the Internet.

2. Description of the Related Art

Traditional methods for collecting marketing information related to consumer reaction to advertisements includes manual processes of presenting proposed and real advertisements to potential consumers selected from a target consumer group, and manual observation of the consumer subject's reaction. These surveys are sometimes conducted in a controlled environment wherein a consumer is brought to a facility so that they can be observed, either directly or indirectly such as from behind a one-way mirror. The subject consumer(s) are typically shown a number of advertisements which a company may be considering using, and their physical reactions are recorded and analyzed. They may also be asked to complete a questionnaire about the advertisement(s) to assess their conscious reaction and their ability to assimilate information presented in the advertisement. This process can also be followed for audio advertisements such as radio spots.

Another method for gauging consumer reaction to advertisements is to meet the consumers in a public environment where they may react differently than they would in a private or laboratory environment. This is typically called “canvassing”, and is used most often conducted in large public environments such as shopping malls, airports, and train stations.

A third method for obtaining information regarding consumer's reaction to advertisements is the system used by firms such as Nielson in which television advertisements and the viewing habits of a family are manually or automatically recorded.

These types of studies of consumer reaction are crucial to selecting and developing an effective advertising campaign for a product or service. The information gathered and analysis results allow the campaign designers to adjust the content of the campaign to produce maximum effect, remove any anti-cultural or objectionable content, and deliver the intended message from the advertisers to the target consumer audience.

The Internet has become a converged media, incorporating capabilities of traditional communication technologies such as telephones and facsimile machines, with entertainment and news capabilities such as broadcast news and broadcast entertainment shows, along with technologies for online commerce and shopping. As such, its potential as a powerful advertising medium has already been recognized but only partially realized.

In recent studies conducted by Jupiter Communications Corporation, it was predicted that within five years, or by the year 2005, an Internet browser will be presented with over 950 Internet based marketing messages per day. The opportunities to present advertising messages during e-mail communication, chat room discussions, web site browsing, online shopping, and online research are virtually limitless.

Many new companies and services have been developed and deployed based upon delivering certain services to the consumer at no charge in return for the ability to provide and to present advertising messages to the consumer during his or her use of the Internet and all of its facilities. Some such companies are NetZero, Bluelight.com, and Juno.

These “free” services are provided under a variety of business models and schemes in which the consumer receives certain services for free in return for their receiving advertisements and having their browsing and usage habits tracked and recorded as part of a marketing study. These companies derive their operating revenue and profit through fees they charge to their advertisers for displaying their advertisements, and through fees collected for collected data regarding consumer browsing and online usage habits sold as marketing information. Most of these companies provide “free” specialized software, and some even provide free Internet access equipment. Some of the companies currently engaged in providing such “free” consumer services are Juno.com, NetZero, AltaVista, Bluelight.com, and People's PC.

One of the method of providing such as service is to provide free Internet access as a dial-up Internet Service Provider (“ISP). Under this model, the ISP requires use of their own Internet browser and e-mail software which is adapted to display advertisements such as banner ads during use. The specialized software may be downloaded from a website, or pre-installed by a manufacturer on a computer. For example, the “free” service provider may provide their customized e-mail and web browsing software to a computer manufacturer, such as IBM, who automatically loads that software on each computer sold. Then, a consumer who purchases that computer can easily register for and use the free services for free. Because the consumer must register for the service before he can use the service, he must also provide certain demographic information to the service, such as age, marital status, sex, hobbies, interests, and income level. This allows the service provider to transmit targeted messages intended for his demographic makeup, and to correlate his usage habits to various demographic consumer groups to which he may belong.

Another method currently in use is to distribute specialized web browser “add-on” software in the form compact discs (“CD”) through retail stores, such as K-Mart. This method allows consumers who already own a computer to easily obtain the software in a physical form, e.g. a CD, take it to their home or office, and install it on their own computer. Through a similar registration process as described supra, the consumer provides demographic information about themselves in order to access free services.

Yet another method employed currently is to provide free personal computers and/or Internet appliances to consumers in exchange for permission to track their habits and Internet usage, and to display advertising messages to them.

While the potential of the Internet as advertising medium has been recognized, the ability to perfect and tune an advertising campaign conducted over the Internet has not been fully developed. Methods similar to the Nielson method or the direct observance method are not currently possible over the Internet as consumers browse the Internet and use the Internet in private almost exclusively. This “private” use occurs whether they are using the Internet during work hours or during personal hours.

The physical input to the computer during browsing can be gauged, of course, such as keystrokes and mouse strokes and the time between “clicks”, but such things as facial expressions and audible reactions cannot be easily judged with currently available technology.

These types of physiological indicators, however, are some of the most important data collected during a typical marketing study. For example, a consumer, when asked, may tell you that he found an advertisement appealing or informative, but his facial expressions may betray his true reaction that he is either confused, amused, or find the message or images offensive.

Therefore, there is a need in the art for a system and method for collecting audible and visual reactions from consumers during online advertising campaigns. This system and method should preferrably interoperate with current and anticipated Internet technology, such as web browsers on personal computers, as well as provide for minimal intrusion to the normal Internet browsing and communications experience.

### BRIEF DESCRIPTION OF THE DRAWINGS

The following detailed description when taken in conjunction with the figures presented herein present a complete description of the present invention.

FIG. 1 illustrates the common arrangement of client-server computers, and especially that arrangement over computer networks such as the Internet.

FIG. 2 shows the basic architecture of the visual marketing server system.

FIG. 3 illustrates the prior art generalized organization of a client Internet device.

FIG. 4 illustrates the logical process of the visual marketing server as it interacts directly with Internet client devices, and indirectly with consumer users of the client devices.

### SUMMARY OF THE INVENTION

The system and method of the invention provide for collecting the visual and audible reaction of a consumer while viewing or experiencing Internet advertising messages. Using the multimedia capabilities of a client device, such as a PC camera and/or a microphone, the system times the presentation of advertising messages on the client device display or speakers, and then captures visual images of the face of the user and audible recordings immediately subsequent to displaying or presenting the advertisement. These captured visual images and audible sounds may then be transmitted as digital files to a digital marketing server, where they may then be processed for recognition of features, such as certain words in a sound file or such as certain expressions in a facial image. Multiple reactions from multiple consumer users may be aggregated to provide a more generalized consumer reaction to a marketing campaign based on a selected group of consumers according to their common demographic characteristics. Additionally, each individual consumer can be delivered different messages depending on their detected reactions to previous similar messages. For example, if a consumer's reaction has been historically negative to a certain kind or format of advertising messages, he may be provided with alternate formats of advertising messages until a format is found that can results in a positive reaction from the consumer.

### DETAILED DESCRIPTION OF THE INVENTION

The foregoing and other objects, features and advantages of the invention will be apparent from the following more particular description of a preferred embodiment of the invention, as illustrated in the accompanying drawings wherein like reference numbers represent like parts of the invention.

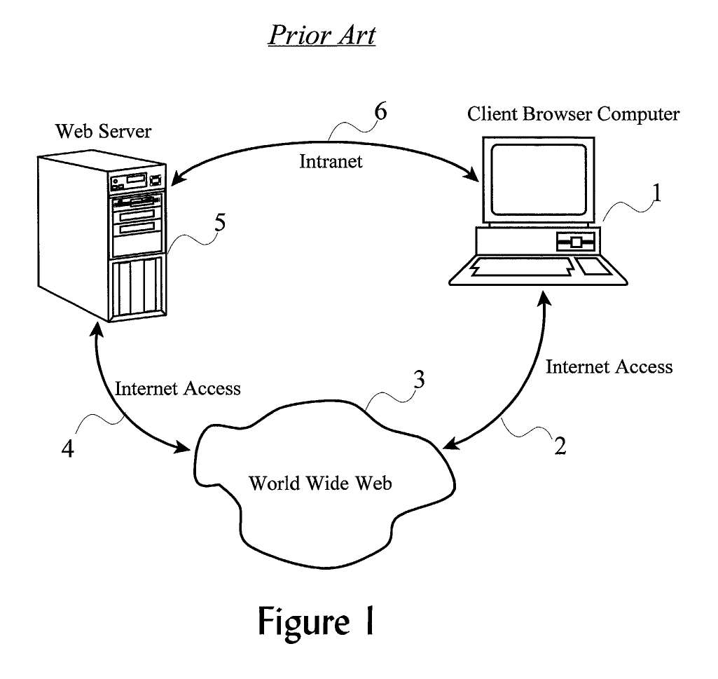

The invention is preferably realized as coordinated software processes or scripts operating on both a visual marketing server and an Internet client device. FIG. 1 shows the fundamental client-server arrangement of Internet and intranet communications. A client web browser computer (1) is provided with Internet access (2) to the World Wide Web (3) through common means such as a dial-up telephone line and modem, cable modem, or local area network (“LAN”). The web browser computer (1) is also provided with appropriate web browsing software, such as Netscape's Navigator or Microsoft's Explorer. A web server computer (5) is likewise provided with Internet access (4) to the World Wide Web (3) using similar means, or higher-bandwidth means such as T1 and T3 data lines, and a web server suite of software. Alternatively, client and servers may be interconnected via an Intranet, such as a corporate LAN. Communications between the client and server machines may use proprietary protocols or suitable, well-known protocols such as Hyper Text Transfer Protocol (“HTTP”) and secure HTTP (“HTTPs”). These arrangements are well known within the art.

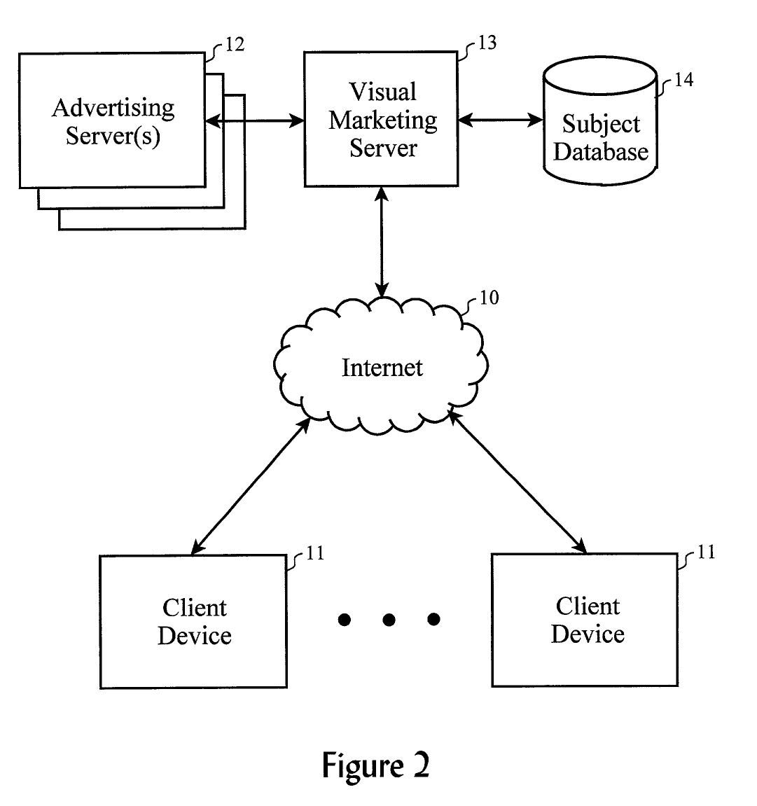

Turning to FIG. 2, the organization of web client devices with the visual marketing server according to the preferred embodiment is shown. Client devices (11) are interconnected to a visual marketing server (13) via a communication network, such as the Internet (10), a wireless network or local area network. The visual marketing server (13) also has access to a subject database (14) containing demographic information and registration information for marketing study consumer subjects. Those consumer subjects are the individuals who are participating in the marketing study. The visual marketing server (13) may also be interfaced to one or more advertising servers (12) which provide a plurality of advertising messages, such as video clips, banner ads, and audio clips.

In the arrangement as shown in FIG. 2, the client device(s), which may be personal computers with web browser software, web enabled wireless telephones, web TV terminals, or other suitable Internet access device, receives marketing advertisements during use of the Internet, or during electronic mail communications. These marketing messages may be transmitted in the form of well-known web objects, such as graphic information format (“GIF”), joint photographic experts group images (“JPEG”), video clips such as AVI, or audio clips such as WAV files. The advertisements may be displayed on a portion of the client device display (or played through the client device speaker) during normal operation of the client device, such as along a top banner or a side bar.

The visual marketing server (13) may access the subject database (14) when a client device attaches to or logs into the server. Based on information in the subject database (14), the visual marketing server (13) may then contact or request from the advertising servers (12) the appropriate advertising messages which match the targeted demographics of the operator of the client device. These advertising messages are then transmitted to the client device for display or replay, and the resulting facial images and/or audible reaction are returned by the client device to the marketing server.

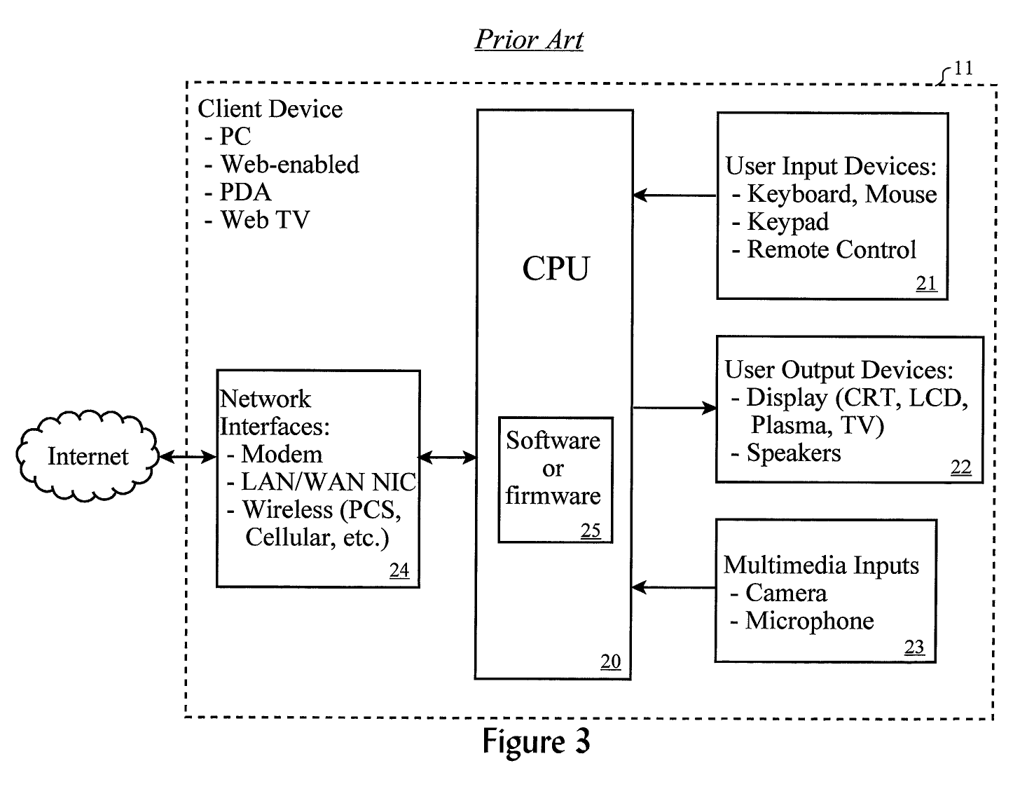

Turning to FIG. 3, the generalized organization of a client device (11) is shown, as is well known in the art. This generalized architecture of a client device describes a variety of client devices, from a personal computer with a web browser such as Netscape's Navigator or Microsoft Explorer, to a web enabled cell phone with an LCD display, Web Television terminal. At the heart of the client device (11) is a central processing unit (“CPU”) (20). This CPU may be a Pentium class processor, such as in the case of a personal computer, or it may be an embedded microprocessor or microcontroller, such as in the case of personal digital assistants (“PDA”) and web enabled wireless telephones.

The client device (11) is also provided with one or more user input devices (21), typically including a keyboard, mouse, keypad, or Infrared remote control such as in the case of WebTV. The client device (11) is also usually provided with one or more user output devices (22), such as a CRT, LCD, plasma, or television display. It may also be equipped with one or more audio speakers.

The client device is preferably equipped with multimedia input devices including a camera and a microphone. Web cameras are common technology employed on personal computers, and are even available for PDA's.

The client device (11) is provided with a network interface (24) such as a dial-up modem, LAN/wan network interface card, digital subscriber line (“DSL”) modem, cable modem, or a wireless communications interface circuit such as a Personal Communications System (“PCS”) or cellular telephone interface.

This organization of functions in the client device (11) allows software or firmware (25) which is executed by the CPU (20) to provide displays and menus of options to the output device (22), and to collect user selections and input through the user input devices (21). The multimedia media inputs (23) are used to collect the visual and audible reactions of the consumer user during the advertising display, replay or presentations. The client device may then transmit those captured visual images and audible sounds to the visual marketing server (13) via a network through the network interface (24) in the form of digital files such as AVI, JPEG, GIF, WAV, or other suitable image and/or audio web objects.

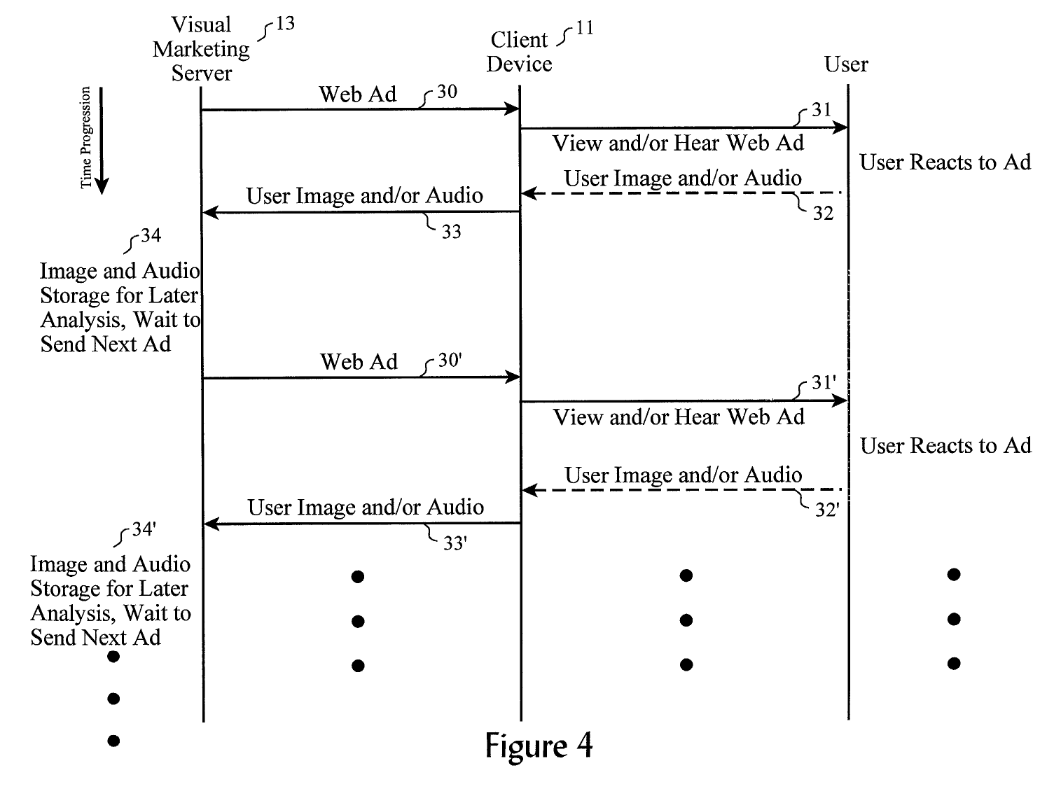

Turning to FIG. 4, the logical process of the invention is disclosed, including communications and data transferred between the visual marketing server (13) and the client device (11). The marketing server (13) initially transmits a web advertisement (30) to the client device (11) during use of the Internet or e-mail facilities of the client device by a user. This advertisement may have been selected based upon the particular user's demographics, registration information, previous reaction history, or it may be randomly selected. The advertisement may be a banner ad, such as a GIF or JPEG image, an HTML page, a video clip, or an audible recording such as a WAV file.

The client device (11) then plays or displays the advertisement such that the user may view and/or hear the web advertisement (31). The user will have a natural reaction to the advertisement, usually comprising facial expression changes, such as a grin, frown or puzzled expression, and possibly audible sounds such as laughter, words, or other noises.

The client device (11) is preferably executing a script, such as a web browser Java script, which times the presentation of the web advertisement (31), and at an appropriate time after the presentation, collects or captures the visual image from the multimedia camera and/or audio recording from the microphone (23). It also may be a short video clip or higher bandwidth devices and applications.

The captured or recorded image and/or sound recording files record the user's reaction to the advertising message. The script or program executing on the client device (11) transmits the captured images and/or audio recordings (33) to the visual marketing server (13). In the preferred embodiment, this is done through a posting operation or through the transmission of a web object which is well-known within the art. The visual marketing server may then simply store the image files and/or audio files for later analysis, or it may immediately proceed with analysis of the image and audio file. For more advanced client devices, the analysis may be performed by the client device CPU and the results transmitted to the marketing server. For example, many common personal computers are equipped with sufficient processing and memory capabilities to perform accurate voice recognition, and as such, could process the captured audio files to find words indicating the user's reaction such as “wow”, “cool” or “no way”.

Algorithms and technologies for providing feature extraction and classification in image files, such as finding and classifying facial features, are well-known within the art. Companies such as Visionics Corporation of New Jersey offer a variety of software and firmware products which are capable of finding and classifying features within a digital photograph of a face, as well as classifying the identity of the person in the digital photograph. Some products are available as objects or modules to run under server and client operating systems, such as Microsoft Windows and IBM's OS/2 operating system, while others are more suitable for embedded firmware applications such as digital signal processor code for specialized camera interface and image capture boards.

Further, products such as IBM's ViaVoice for recognition of words in digitized speech are also readily available, both for server-side and client-side implementation.

These software and firmware recognition and classification products and technologies are well-known in the art.

The stored image files and audio files may either be processed by the visual marketing server itself, or transmitted to another server suitable for providing or performing analysis on the files.

The visual marketing server (13) may then, on a timed interval basis, select another marketing ad, and transmit (30′) it to the client device (11). Again, the client device script or program would then time the presentation of the audio and/or visual advertisement (31′), and would automatically collect the image from the camera and/or recording from the microphone (32′) in order to capture the consumer user's reaction. This captured user image data and/or audio data (33′) would then be transmitted by the client device (11) to the visual marketing server (13) as described supra.

The process may be repeated on a timed basis for the duration of the user's online activities, such as browsing the Internet or using e-mail. Of particular interest to an advertiser may be a feature whereby the user's expressions and reactions are tracked as he “browses the advertisement” trail. For example, while viewing a generic web page, a banner ad is displayed at the top of the page, and the banner ad is hyperlinked to another website or series of ads. The user notices and favorably reacts to the banner ad, and clicks on the ad. This can invoke a small session of recording the user's next few clicks and reactions, or throughout his next “thread of browsing”, as he or she views the subsequent ads and presentations. These reactions can then be analyzed for useful information, such as indications that the user was initially smiling when he selected the banner ad, but after reviewing the entire ad sequence, had lost the smile and used the browser's BACK button to return to his starting point.

A further feature of the invention allows the stored user reaction visual image files and audio files to be collected over a period of time for multiple consumer users. Those collected “group” reactions are aggregated to form a database of reactions for that demographic group of consumers. These aggregated reaction data files may then be analyzed, such as in a batch analysis process, and group statistics may be generated, such as a percentage of consumers who had favorable reactions, a percentage of consumers who had negative reactions, and a percentage of consumers who had indifferent reactions.

Another advantageous capability provided by the invention is the ability to adapt a marketing campaign and marketing messages delivered to a specific consumer based upon his or her historical reactions to certain types of marketing messages. For example, if a consumer is initially delivered information regarding sporting goods advertisement, but the reactions received from a number of those advertisements are generally negative from that consumer, his profile may be updated by the visual marketing server to remove sporting goods advertisements from his preferred category lists. The visual marketing servers then could proceed to delivering other types of messages such as news clips or advertisements regarding books and literature. If the consumer's reaction is analyzed as being positive to those types of advertisements, the marketing server may then mark that consumer's profile as preferring those types of advertising messages.

It will be understood from the foregoing description that various modifications and changes may be made in the disclosed preferred embodiment of the invention without departing from its true spirit and scope, such as the use of alternate programming methodologies or languages, alternate computer platforms and software, operating systems and communications protocols. It is intended that this description is for purposes of illustration only and should not be construed in a limiting sense. The scope of this invention should be limited only by the language of the following claims.

What is claimed is:

1. A method for conducting analysis of consumer reaction to marketing and advertising messages and campaigns over computer networks such as the Internet, said marketing and advertising messages being delivered from a server computer to a client device via a computer network in forms such as web objects, graphic image files, audio recording files, and video segment files, said method comprising the steps of:
transmitting a selected advertising message to a client device for presentation to a consumer user;
automatically recording at least one consumer user reaction on a timed interval basis relative to the time of presentation of said selected advertising message; and
transmitting one or more recorded consumer user reactions to a marketing server from said client device via a computer network such that said recorded consumer user reaction may be reviewed or otherwise analyzed.

2. The method as set forth in claim 1 wherein said step of recording at least one consumer user reaction comprises capturing a visual image of a consumer user's face from an electronic camera associated with said client device.

3. The method as set forth in claim 2 further comprising the step of automatically analyzing said captured visual images for indications of favorable, disfavorable, and indifferent reactions to said advertising message.

4. The method as set forth in claim 1 wherein said set of recording at least one consumer user reaction comprises capturing an audible recording from a microphone associated with said client device.

5. The method as set forth in claim 4 further comprising the step of automatically analyzing said captured audible recordings for indications of favorable, disfavorable, and indifferent reactions to said advertising message.

6. The method as set forth in claim 1 further comprising the step of collecting transmitted recorded consumer user reactions for a plurality of consumer users for further analysis on a group or statistical basis.

7. The method as set forth in claim 1 further comprising the step of collecting transmitted recorded consumer user reactions for a single consumer user during a thread of browsing advertisement for further analysis of a consumer user's reaction to a series of advertisements or presentations.

8. The method as set forth in claim 1 further comprising the step of selecting additional advertising messages for transmission to a consumer user based upon a consumer user's preferences and a consumer user's historical reaction to previous advertising messages.

9. A computer-readable medium containing program code for conducting analysis of consumer reaction to marketing and advertising messages and campaigns over computer networks such as the Internet, said marketing and advertising messages being delivered from a server computer to a client device via a computer network in forms such as web objects, graphic image files, said client devices being capable of executing program code, said program code when executed causing a client device to perform the steps of:
receiving an advertising message for presentation to a consumer user;
recording at least one consumer user reaction on a timed interval basis relative to the time of presentation of said advertising message; and
transmitting one or more recorded consumer user reactions to a marketing server from said client device via a computer network such that said recorded consumer user reaction may be reviewed or otherwise analyzed.

10. The computer-readable medium as set forth in claim 9 wherein said program code for recording at least one consumer user reaction comprises program code for capturing a visual image of a consumer user's face from an electronic camera associated with said client device.

11. The computer-readable medium as set forth in claim 10 further comprising program code for automatically analyzing said captured visual images for indications of favorable, disfavorable, and indifferent reactions to said advertising message.

12. The computer-readable medium as set forth in claim 9 wherein said program code for recording at least one consumer user reaction comprises program code for capturing an audible recording from a microphone associated with said client device.

13. A computer-readable medium containing program code for conducting analysis of consumer reaction to marketing and advertising messages and campaigns over computer networks such as the Internet, said marketing and advertising messages being delivered from a server computer to a client device via a computer network in forms such as web objects, graphic image files, said server computer being capable of executing program code, said program code when executed causing a server computer to perform the steps of:
transmitting to a client device via a computer network an advertising message for presentation to a consumer user; and
receiving from a client device via a computer network one or more recorded consumer user reactions such that said recorded consumer user reaction may be reviewed, stored or otherwise analyzed.

14. The computer-readable medium as set forth in claim 13 wherein said program code for receiving at least one consumer user reaction comprises program code for receiving a visual image of a consumer user's face from an electronic camera associated with said client device.

15. The computer-readable medium as set forth in claim 14 further comprising program code for automatically analyzing said received visual images for indications of favorable, disfavorable, and indifferent reactions to said advertising message.

16. The computer-readable medium as set forth in claim 13 wherein said program code for receiving at least one consumer user reaction comprises program code for receiving an audible recording from a microphone associated with said client device.

17. The computer-readable medium as set forth in claim 16 further comprising program code for automatically analyzing said received audible recordings for indications of favorable, disfavorable, and indifferent reactions to said advertising message.

18. The computer-readable medium as set forth in claim 13 further comprising program code for collecting received recorded consumer user reactions for a plurality of consumer users for further analysis on a group or statistical basis.

19. The computer-readable medium as set forth in claim 13 further comprising program code for selecting advertising messages for transmission to a particular consumer user based upon a consumer user's preferences and a consumer user's historical reaction to previous advertising messages.

20. A system for conducting analysis of consumer reaction to marketing and advertising messages and campaigns over computer networks such as the Internet, said marketing and advertising messages being delivered from a server computer to a client device via a computer network in forms such as web objects, graphic image files, said client device having a processor for executing program code, a network interface for communicating to a server via a computer network, at least one user output device, and at least one user input device, said system comprising:
an receiver for advertising messages from a server via a computer network through said network interface;
an advertising message presenter for presenting an advertising message;
a consumer user reaction recorder, operable on a timed interval basis relative to the time of presentation of said advertising message; and
a reaction transmitter for sending one or more recorded consumer user reactions to a marketing server from said client device via a computer network such that said recorded consumer user reaction may be reviewed or otherwise analyzed.

21. The system as set forth in claim 20 wherein said recorder for a consumer user reaction comprises a visual image capturing device for recording an image of a consumer user's face from an electronic camera associated with said client device.

22. The system medium as set forth in claim 21 further comprising an analyzer for analysis of said captured visual images for indications of favorable, disfavorable, and indifferent reactions to said advertising message.

23. The system as set forth in claim 20 wherein said recorder for a consumer user reaction comprises an audible sound recorder for recording sound from a microphone associated with said client device.

24. A system for conducting analysis of consumer reaction to marketing and advertising messages and campaigns over computer networks such as the Internet, said marketing and advertising messages being delivered from a server computer to a client device via a computer network in forms such as web objects, graphic image files, said server computer having a processor for executing program code, a network interface for communicating to a client device via a computer network, said system comprising:
an transmitter for sending advertising messages from a server to a client device via a computer network through said network interface;
a consumer reaction recording receiver for receiving one or more recorded consumer user reactions from a client device via a computer network such that said recorded consumer user reaction may be reviewed, stored or otherwise analyzed.

25. The system as set forth in claim 24 wherein said consumer reaction recording receiver is adapted to receive visual image data of a consumer user's face from an electronic camera associated with said client device.

26. The system as set forth in claim 25 further comprising an analyzer for said received visual image data for indications of favorable, disfavorable, and indifferent reactions to said advertising message.

27. The system as set forth in claim 24 wherein said consumer reaction recording receiver is adapted for receiving audible recording data from a microphone associated with said client device.

28. The system as set forth in claim 27 further comprising an analyzer for said received audible recordings for indications of favorable, disfavorable, and indifferent reactions to said advertising message.

29. The system as set forth in claim 27 further a group reaction collector for collecting and aggregating received recorded consumer user reactions for a plurality of consumer users for further analysis on a group or statistical basis.

30. The system as set forth in claim 27 further comprising an advertising message selector for selecting advertising messages from a plurality of available advertising messages for transmission to a particular consumer user based upon a consumer user's preferences and a consumer user's historical reaction to previous advertising messages.
